(19) United States
(12) Patent Application Publication
(10) Pub. No.: US 2015/0154513 A1
(43) Pub. Date: Jun. 4, 2015

(54) SYSTEMS AND METHODS FOR ENHANCED TICKET SALES

(71) Applicants: Ryan E. Kennedy, San Jose, CA (US); Jayanth Vasudevan, Fremont, CA (US); Jeffrey T. Spaulding, San Francisco, CA (US); Nikhil Sukhtankar, Fremont, CA (US)

(72) Inventors: Ryan E. Kennedy, San Jose, CA (US); Jayanth Vasudevan, Fremont, CA (US); Jeffrey T. Spaulding, San Francisco, CA (US); Nikhil Sukhtankar, Fremont, CA (US)

(21) Appl. No.: 14/097,119

(22) Filed: Dec. 4, 2013

(51) Int. Cl. G06Q 10/02; G06Q 50/00; G06Q 30/06

(52) U.S. Cl. CPC G06Q 10/02; G06Q 30/06; G06Q 50/01

(57) ABSTRACT

Computing systems and methods for enhanced ticket sales are provided. The enhanced ticket sales may include presentation of community-sourced seat information to a potential ticket buyer that describes the human experience of sitting in each particular seat at a venue. The community-sourced seat information for each particular seat can be photos, comments, or other data that have been gathered by a ticket server from online content posted by people that have attended previous events in that seat. The online content can be gathered from email accounts, social network accounts, or other online sources. In this way, the human experience of some or all of the people who have sat in a particular seat at various events, as recorded in photos, comments, articles or other online data, can be collected, filtered, and provided to a potential purchaser of a ticked for that seat.

### BACKGROUND

1. Technical Field

The present disclosure relates generally to electronic commerce, and more particularly, to the presentation of seat information associated with automated ticket purchase transactions.

2. Related Art

Computer systems and networks have facilitated the tasks of buying, selling and transferring goods. For example, global computer networks, such as the Internet, have allowed purchasers to relatively quickly and efficiently seek and purchase goods online. Similarly, global computer networks provide an efficient and cost-effective medium for sellers to advertise, offer, provide, and sell their goods. Electronic commerce companies provide buyers and sellers with online services and the infrastructure to accept orders of goods from remote purchasers, to perform the financial transactions necessary to confirm and complete the sale of goods, to ship or distribute the goods to remote purchasers, and to perform other related logistics.

One example of a market for goods within the realm of electronic commerce is the online ticket market. Various online ticket sellers provide websites through which parties can buy and sell tickets online. These tickets can be obtained by a user to reserve seats and/or admission for a variety of live events, such as sporting events, concerts, theater events, and other entertainment events. Typically, a buyer looks for available tickets on a ticket marketplace website or other online listing and decides which, if any, of the available tickets are of interest to the buyer for possible purchase.

In a conventional online listing of tickets, the buyer is presented with a description of the ticket price and a seat location of the seats associated with the tickets. The buyer can also be provided with a venue map that shows the location of a seat or group of seats within the venue. However, it can be difficult for a potential buyer to obtain additional information that informs the potential buyer of the human experience of attending an event at that seat location.

It may therefore be desirable to provide systems and methods for providing enhanced ticket information for various ticketed events.

### BRIEF DESCRIPTION OF THE DRAWINGS

FIG. 1 is a block diagram of an illustrative computing system that is adapted for implementing the selection and purchase of tickets for ticketed events using enhanced ticket information according to an embodiment.

FIG. 2 is a block diagram of an illustrative computer system suitable for implementing on one or more devices of the computing system in FIG. 1 according to an embodiment.

FIG. 3 is a block diagram of an illustrative system for gathering and providing enhanced ticket information for the selection and purchase of tickets for ticketed events according to an embodiment.

FIG. 4 is a diagram of an illustrative service provider web page showing how a user may be provided with enhanced ticket information according to an embodiment.

FIG. 5 is an illustrative portion of a list of available tickets showing how enhanced ticket information may be presented to a user according to an embodiment.

FIG. 6 is a flowchart showing an illustrative process that may be performed by a ticket provider for gathering enhanced ticket information according to an embodiment.

FIG. 7 is a flowchart showing an illustrative process that may be performed by a ticket provider for presenting enhanced ticket information to a potential ticket buyer according to an embodiment.

FIG. 8 is a flowchart showing an illustrative process that may be performed by a ticket provider for gathering enhanced ticket information directly from a user according to an embodiment.

### DETAILED DESCRIPTION

Exemplary applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible, such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting, such that other embodiments may be used, and changes may be made without departing from the spirit and scope of the invention.

Devices, systems and methods are provided for performing activities related to the online purchase of tickets to ticketed events. In various particular embodiments, the devices, systems or methods can involve one or more devices in communication over a network. Such devices, systems, and methods can facilitate the selection and purchase of tickets to various ticketed events using enhanced ticket information such as community-sourced seat information.

The community-sourced seat information may include information associated with a particular seat, group of seats, seat section, venue section without seats (e.g., a general admission section or a portion of a general admission section), another location within a venue, another location outside of a venue, or any other suitable geographical location that has been gathered from various online sources. The online sources may be email accounts of users of a ticket server, social network accounts of users of the ticket server, and/or public webpages of the user, friends of the user, or any other person or group of people that has attended an event at a particular seat and posted information about the seat online. The posted information can be photos taken at an event from a particular seat or group of seats, published comments about the experience of attending and event at a particular seat or group of seats, videos taken at an event from a particular seat or group of seats, or any other information that informs a potential ticket buyer of the human experience of attending an event at that particular seat or group of seats (or other geographical location).

The community-sourced seat information that is presented to a user of a ticket provider (e.g., a potential ticket buyer) can be filtered to include relatively important content for that user such as information that has been sourced (gathered) from friends of the user, people in the user's social networks, and/or people with similar interests as the user (as examples).

While the various examples disclosed herein focus on particular aspects regarding the online purchase of tickets, it will be understood that the various inventive principles and embodiments disclosed herein can be applied to other types of ticketed applications and arrangements as well. For example, a ticket purchase that is performed in person or on a closed or proprietary computing system may utilize one or more of the aspects and features found in the various systems and methods provided. In one embodiment, it is contemplated that community-sourced information associated with any geographical location (e.g., a tourist attraction, a highway location, a restaurant, a beach, or any other location) can be received or otherwise gathered by a networked system using one or more aspects and features found in the various systems and methods provided to provide community-sourced information about the location to a user of the system.

Reference throughout the specification to “various embodiments,” “some embodiments,” “one embodiment,” “an embodiment,” “various examples,” “one example,” “an example,” or “some examples” means that a particular feature, structure, or characteristic described in connection with the embodiment or example is included in at least one embodiment. Thus, appearances of these are not necessarily all referring to the same embodiment. Furthermore, the particular features, structures or characteristics may be combined in any suitable manner in one or more embodiments.

According to an embodiment, a computer program product can comprise a non-transitory machine readable medium. The non-transitory machine readable medium can have computer readable and executable code for instructing one or more processors to perform any of the methods disclosed herein.

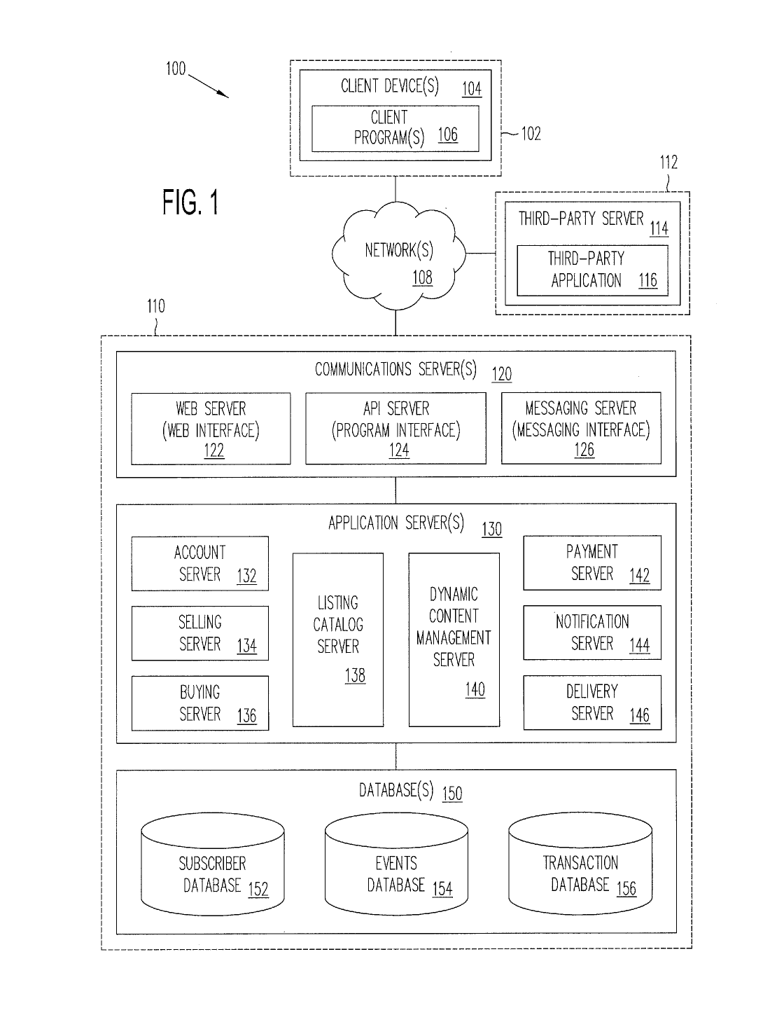

Beginning with FIG. 1, an exemplary embodiment of a computing system adapted for implementing the selection and purchase tickets for ticketed events using enhanced ticket information is illustrated in block diagram format. As shown, a computing system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

Computing system 100 can include, among various devices, servers, databases and other elements, a client 102 that may comprise or employ one or more client devices 104, such as a laptop, a mobile computing device, a PC, and/or any other computing device having computing and/or communications capabilities in accordance with the described embodiments. In particular, it is specifically contemplated that client devices 104 can include a cellular telephone or other similar mobile device that a user can carry on or about his or her person and access readily.

Client devices 104 generally may provide one or more client programs 106, such as system programs and application programs to perform various computing and/or communications operations. Exemplary system programs may include, without limitation, an operating system (e.g., MICROSOFT® OS, UNIX® OS, LINUX® OS, Symbian OS™, Embedix OS, Binary Run-time Environment for Wireless (BREW) OS, JavaOS, a Wireless Application Protocol (WAP) OS, and others), device drivers, programming tools, utility programs, software libraries, application programming interfaces (APIs), and so forth. Exemplary application programs may include, without limitation, a web browser application, messaging applications (e.g., e-mail, IM, SMS, MMS, telephone, voicemail, VoIP, video messaging), contacts application, calendar application, electronic document application, database application, media application (e.g., music, video, television), location-based services (LBS) application (e.g., GPS, mapping, directions, point-of-interest, locator), and so forth. One or more of client programs 106 may display various graphical user interfaces (GUIs) to present information to and/or receive information from one or more of client devices 104.

As shown, client 102 can be communicatively coupled via one or more networks 108 to a network-based system 110. Network-based system 110 may be structured, arranged, and/or configured to allow client 102 to establish one or more communications sessions with network-based system 110 using various computing devices 104 and/or client programs 106. Accordingly, a communications session between client 102 and network-based system 110 (e.g., a communications session for selection and/or purchase of tickets for a ticketed event using enhanced ticket information) may involve the unidirectional and/or bidirectional exchange of information and may occur over one or more types of networks 108 depending on the mode of communication. While the embodiment of FIG. 1 illustrates a computing system 100 deployed in a client-server operating environment, it is to be understood that other suitable operating environments and/or architectures may be used in accordance with the described embodiments.

Data and/or voice communications between client 102 and the network-based system 110 may be sent and received over one or more networks 108 such as the Internet, a WAN, a WWAN, a WLAN, a mobile telephone network, a landline telephone network, a VoIP network, as well as other suitable networks. For example, client 102 may communicate with network-based system 110 over the Internet or other suitable WAN by sending and or receiving information via interaction with a web site, e-mail, IM session, and/or video messaging session. Any of a wide variety of suitable communication types between client 102 and system 110 can take place, as will be readily appreciated. In particular, wireless communications of any suitable form may take place between client 102 and system 110, such as that which often occurs in the case of mobile phones or other personal mobile devices.

In various embodiments, computing system 100 can include, among other elements, a third party 112, which may comprise or employ a third-party server 114 hosting a third-party application 116. In various implementations, third-party server 114 and/or third-party application 116 may host a web site associated with or employed by a third party 112. For example, third-party server 114 and/or third-party application 116 may enable network-based system 110 to provide client 102 with additional services and/or information, such as additional ticket inventory and/or enhanced ticket information such as community-sourced seat information. In one embodiment, third party server 112 may include a social networking server that hosts a user's social network account. In another embodiment, third party server 112 may include an email server that hosts a user's email account. In some embodiments, one or more of client programs 106 may be used to access network-based system 110 via third party 112. For example, client 102 may use a web client to access and/or receive content from network-based system 110 after initially communicating with a third-party web site 112.

Network-based system 110 may comprise one or more communications servers 120 to provide suitable interfaces that enable communication using various modes of communication and/or via one or more networks 108. Communications servers 120 can include a web server 122, an API server 124, and/or a messaging server 126 to provide interfaces to one or more application servers 130. Application servers 130 of network-based system 110 may be structured, arranged, and/or configured to provide various online marketplace and/or ticket fulfillment services to users that access network-based system 110. In various embodiments, client 102 may communicate with applications servers 130 of network-based system 110 via one or more of a web interface provided by web server 122, a programmatic interface provided by API server 124, and/or a messaging interface provided by messaging server 126. It can be appreciated that web server 122, API server 124, and messaging server 126 may be structured, arranged, and/or configured to communicate with various types of client devices 104 and/or client programs 106 and may interoperate with each other in some implementations.

Web server 122 may be arranged to communicate with web clients and/or applications such as a web browser, web browser toolbar, desktop widget, mobile widget, web-based application, web-based interpreter, virtual machine, and so forth. API server 124 may be arranged to communicate with various client programs 106 and/or a third-party application 116 comprising an implementation of API for network-based system 110. Messaging server 126 may be arranged to communicate with various messaging clients and/or applications such as e-mail, IM, SMS, MMS, telephone, VoIP, video messaging, and so forth, and messaging server 126 may provide a messaging interface to enable access by client 102 and/or third party 112 to the various services and functions provided by application servers 130.

When implemented as an online ticket marketplace, application servers 130 of network-based system 110 may provide various online marketplace and ticket fulfillment services including, for example, account services, buying services, selling services, listing catalog services, dynamic content management services, delivery services, payment services, gathering services, and notification services. Application servers 130 may include an account server 132, a selling server 134, a buying server 136, a listing catalog server 138, a dynamic content management server 140, a payment server 142, a notification server 144, and/or a delivery server 146 structured and arranged to provide such online marketplace and ticket fulfillment services.

Application servers 130, in turn, may be coupled to and capable of accessing one or more databases 150 including a subscriber database 152, an active events database 154, and/or a transaction database 156. Databases 150 generally may store and maintain various types of information for use by application servers 130 and may comprise or be implemented by various types of computer storage devices (e.g., servers, memory) and/or database structures (e.g., relational, object-oriented, hierarchical, dimensional, network) in accordance with the described embodiments.

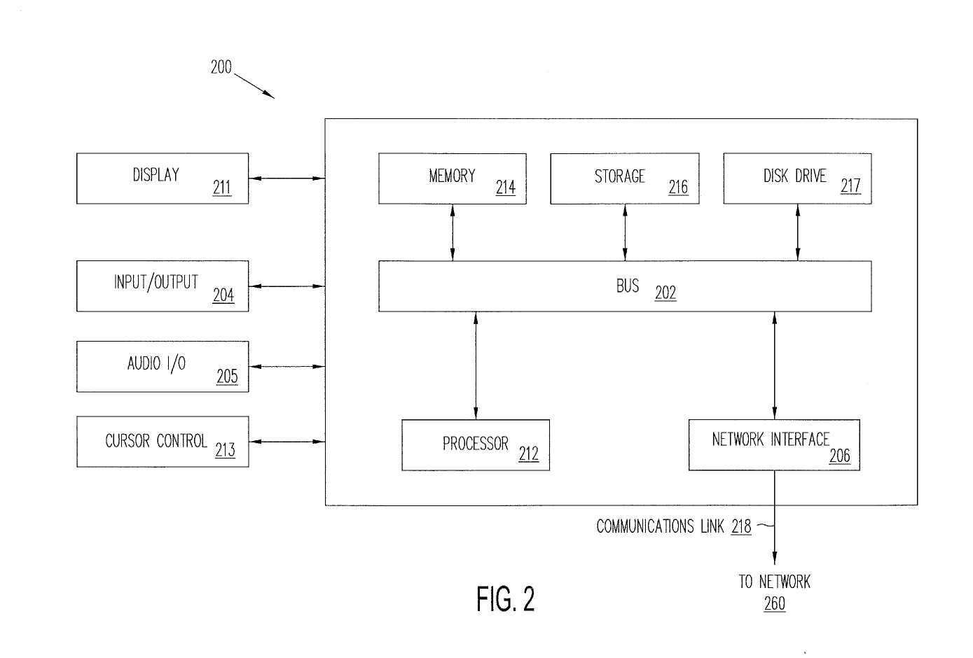

Continuing with FIG. 2, an exemplary computer system 200 suitable for implementing on one or more devices of the computing system in FIG. 1 is depicted in block diagram format. In various implementations, a device that includes computer system 200 may comprise a personal computing device (e.g., a smart or mobile phone, a computing tablet, a personal computer, laptop, PDA, Bluetooth device, key FOB, badge, etc.) that is capable of communicating with a network. The ticket provider and/or a payment provider may utilize a network computing device (e.g., a network server) capable of communicating with the network. It should be appreciated that each of the devices utilized by users, ticket providers, and payment providers may be implemented as computer system 200 in a manner as follows.

Computer system 200 can include a bus 202 or other communication mechanism for communicating information data, signals, and information between various components of computer system 200. Components include an input/output (I/O) component 204 that processes a user action, such as selecting keys from a keypad/keyboard, selecting one or more buttons or links, etc., and sends a corresponding signal to bus 202. I/O component 204 may also include an output component, such as a display 211 and a cursor control 213 (such as a keyboard, keypad, mouse, etc.). An optional audio input/output component 205 may also be included to allow a user to use voice for inputting information by converting audio signals. Audio I/O component 205 may allow the user to hear audio. A transceiver or network interface 206 transmits and receives signals between computer system 200 and other devices, such as another user device, a merchant server, a venue server, an email server, a social networking server, other third-party servers, and/or a payment provider server via a network. In various embodiments, such as for many cellular telephone and other mobile device embodiments, this transmission can be wireless, although other transmission mediums and methods may also be suitable. A processor 212, which can be a micro-controller, digital signal processor (DSP), or other processing component, processes these various signals, such as for display on computer system 200 or transmission to other devices over a network 260 via a communication link 218. Again, communication link 218 can simply be a wireless communication form in some embodiments. Processor 212 may also control transmission of information, such as cookies or IP addresses, to other devices.

Components of computer system 200 also include a system memory component 214 (e.g., RAM), a static storage component 216 (e.g., ROM), and/or a disk drive 217. Computer system 200 performs specific operations by processor 212 and other components by executing one or more sequences of instructions contained in system memory component 214. Logic may be encoded in a computer readable medium, which may refer to any medium that participates in providing instructions to processor 212 for execution. Such a medium may take many forms, including but not limited to, non-volatile media, volatile media, and transmission media. In various implementations, non-volatile media includes optical or magnetic disks, volatile media includes dynamic memory, such as system memory component 214, and transmission media includes coaxial cables, copper wire, and fiber optics, including wires that comprise bus 202. In one embodiment, the logic is encoded in non-transitory machine-readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 200. In various other embodiments of the present disclosure, a plurality of computer systems 200 coupled by communication link 218 to the network (e.g., such as a LAN, WLAN, PTSN, and/or various other wired or wireless networks, including telecommunications, mobile, and cellular phone networks) may perform instruction sequences to practice the present disclosure in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Such software may be stored and/or used at one or more locations along or throughout the system, at client 102, network-based system 110, or both. Where applicable, the ordering of various steps described herein may be changed, combined into composite steps, and/or separated into sub-steps to provide features described herein.

The foregoing networks, systems, devices, and numerous variations thereof can be used to implement a ticket selection and purchase operation such as the selection and purchase tickets for seats at events using enhanced ticket information such as community-sourced seat information associated with the seats.

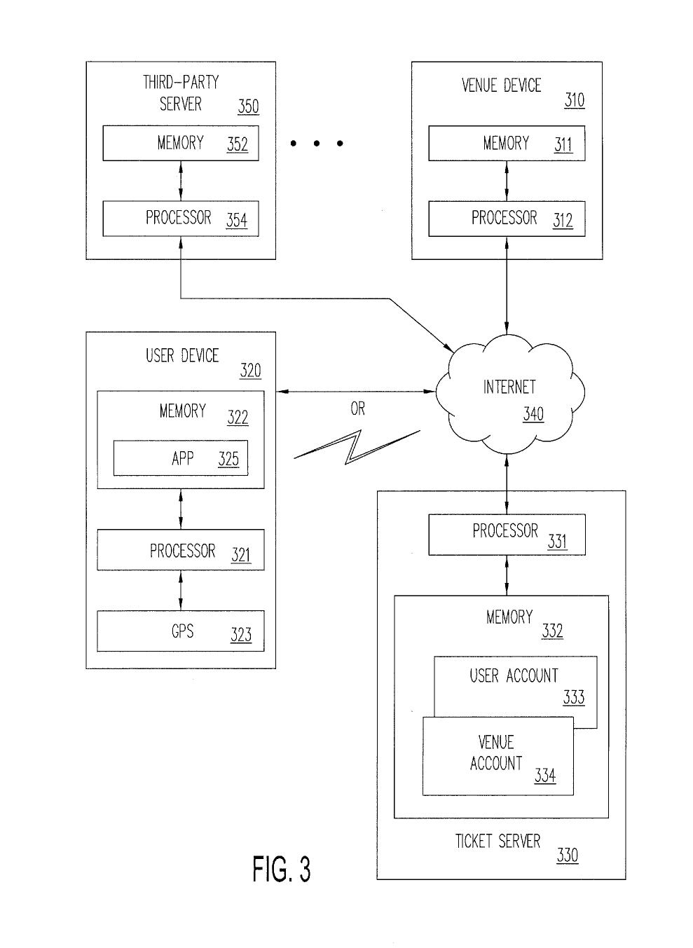

FIG. 3 is a block diagram showing a ticket selection and purchase system that may be used to gather seat-related data and/or section related data associated with seats at events from various sources and provide some or all of the gathered data to a user of the system, according to an embodiment. As shown in FIG. 3, a ticket server 330 may be in communication with one or more user devices such as user device 320, one or more venue devices such as venue device 310, and one or more third-party servers such as third-party server 350.

In some embodiments, a venue device such as a venue device 310 can be present at each of a plurality of different event venues (e.g., stadiums, theaters, arenas, amphitheaters, or other venues at which ticketed events are held). Venue device 310 can provide information regarding events scheduled to occur at a particular venue and regarding seating at that venue. Venue device 310 can provide the information to a ticker server 330. Ticket server 330 can obtain information regarding events scheduled to occur at various venues and information regarding seating at the various venues from one or more venue devices 310, from other sources, or ticket server 330 may have a database of event information and venue information independent of any interaction with a venue device. Ticket server 330 may, for example, be an implementation of system 110 of FIG. 1.

Venue device 310 can be a computer, a server, a computing tablet, or a mobile device, as examples. Venue device 310 can have processing circuitry such as processor 312 and storage such as memory 311. Processor 312 can execute a software program stored in memory 311 for providing information regarding events scheduled to be at the venue and regarding seating at the venue for each scheduled event. Venue device 310 can provide the information to the ticket server and/or to a user device such as user device 320.

Venue device 310 can be disposed at the venue. However, this is merely illustrative. If desired, venue device 310 can be disposed at a location other than the venue. Each venue can have a dedicated venue device 310 or a plurality of different venues can share a common venue device 310. For example, co-owned venues can share a common venue device 310.

In some embodiments, venue device 310 can be omitted if ticket server 330 has the information needed for buying and selling of tickets. For example, ticket server 330 may have a database of available tickets and information about the tickets and venues that enables ticket server 330 to provide the necessary information to a user for purchasing tickets to events at venues.

Third party servers such server 350 may include, for example, a social media server that hosts one or more social networking accounts (e.g., a social networking account for a user of user device 320) and/or an email server that hosts email services (e.g., an email account for the user). A user may use user device 320 to post photos, comments, videos, or other data to a social networking site that is hosted by one of servers 350. The user may also use user device 320 to send, store, and receive emails or other electronic communications on an email account that is hosted by one of servers 350. The user may also use user device 320 to access ticket server 330 to select and purchase tickets for ticketed events from ticket server 330, to sell tickets for ticketed events, and/or view community-sourced seat information (e.g., information gathered from an online community that describes the experience of a person or persons who have attended an event at the venue) for a seat or group of seats at a venue.

Ticket server 330 can obtain community-sourced seat information associated with particular seats or groups of seats from servers 350 (e.g., by scraping emails in an email account that is hosted by a server 350 and crawling webpages or otherwise accessing data such as user social network data in accounts hosted by a server 350). However, this is merely illustrative. If desired, ticket server 330 can gather and store community-sourced seat information directly from users of server 330 (e.g., users who have previously purchased tickets using server 330).

Third party server 350 can be a computer, a server, a computing tablet, or a mobile device, as examples. Server 350 can have processing circuitry such as processor 354 and storage such as memory 352.

A processor 354 on a server 350 can execute one or more software programs stored in memory 352 for publishing user photos, videos, comments, captions, or other data such that are posted by the user. A processor 354 on another server 350 can store (e.g., using memory 352) and route emails or other communications for the user.

In one embodiment, servers 350 can be omitted if ticket server 330 has the information (e.g., seat information) needed generate enhanced ticket information to be provided to a user. For example, ticket server 330 may have a database of purchased tickets and previously obtained information about the seats associated with those tickets to enable ticket server 330 to provide the enhanced ticket information to potential buyers searching for and/or purchasing tickets using ticket server 330.

A user (e.g., a potential ticket purchaser) can use a device such as a user device 320 to shop online for available tickets for one or more events. User device 320 can be a mobile device such as a cellular telephone, a tablet computer, a laptop computer, or another portable computing device. User device 320 can be a non-mobile device such as a home (land line) telephone, a desktop computer, an interactive set top box, or the like. User device 320 can be any device or combination of devices that facilitate online ticket purchasing. User device 320 may, for example, be an implementation of client device 104 of FIG. 1.

User device 320 can have a processor 321, a memory 322, a global positioning system (GPS) 323 and/or other suitable device components. Processor 321 can execute an application such as an app 325 that facilitates the ticket selection and/or purchase methods disclosed herein. App 325 can be stored in memory 322. App 325 can provide a graphical user interface (GUI) for the user when the user is selecting and purchasing tickets online. If desired, app 325 can be a dedicated ticket purchasing app. However, this is merely illustrative. In some configurations, app 325 can be part of another app, such as a Paypal, Inc. payment provider app.

User device 320 can communicate with venue device 310, third-party server 350, and/or ticket server 330 via a network. For example, user device 320 can communicate with venue device 310, third-party server 350, and/or ticket server 330 via the Internet 340. User device 320 can communicate with the Internet via either a wired connection or a wireless connection.

Ticket server 330 may be operated by an online ticket seller such as StubHub, Inc. Ticket server 330 can facilitate online ticket sales. Ticket server 330 may include processing circuitry such as a processor 331 in communication with storage such as a memory 332. Processor 331 can include one or more processors. Processor 331 can access accounts such as a user account 333 and/or a venue account 334 that are stored in memory 332. User account 333 can include information regarding the user (e.g., identification information, preferences, account numbers, purchase history, social network contacts, email contacts, email account permissions, social media account permissions, event-related mementos, purchased-ticket event information, attended event information, etc.). Venue account 334 can include information regarding the venue (e.g., information regarding events, seating, and other venue features). Memory 332 can be separate from the ticker server and can be used to store any number of user accounts 333 and venue accounts 334. Memory 332 can be distributed, e.g., have portions thereof disposed at a plurality of different locations. Other accounts may also be accessible by processor 331, such as accounts of users selling tickets that include ticket details, such as price, quantity, location, and event information, and financial information that enables funds to be deposited into seller accounts when their tickets are sold.

Ticket server 330 may include one or more servers located at one or more locations. Thus, the ticket server 330 can be geographically and operationally distributed if desired. Ticket server 330 can be part of another system, such as a payment provider system. Venue device 310 and/or third-party server 350 can communicate with ticket server 330 over a wired or wireless connection such as via a network. For example, venue device 310 and/or third-party server 350 can communicate with ticket server 330 via Internet 340. Venue device 310 and/or third-party server 350 can communicate with a plurality of different ticket servers 330. Ticket server 330 can communicate with a plurality of different venue devices 310 and/or third-party servers 350. A plurality of different ticket servers 330 can communicate among themselves and can be considered herein as being the same as a single ticket server 330. The user can operate user device 320 to interact with ticket server 330 so that the user can select and purchase tickets (e.g., using enhanced ticket information provided by ticket server 330) online.

Ticket server 330 can communicate with venue device 310 to obtain information about the venue. For example, ticket server 330 can communicate with venue device 310 to obtain information regarding the scheduling of events at the venue and regarding features of the venue. The features of the venue can be dependent upon the events of the venue, e.g., the features of the venue can vary from event to event. Generally, venue device 310, mobile device 320, third-party server 350, and ticket server 330 can perform functions discussed herein. That is, at least to some extent, a function that is discussed herein as being performed via a particular one of these devices can be performed by a different one of these devices, by a combination of these devices, and/or by other devices.

Venue device 310, user device 320, third-party server 350, other mobile devices, and server 330 can communicate with one another via a network, such as the Internet 340. Venue device 310, user device 320, third-party server 350, other mobile devices, and server 330 can communicate with one another via one or more networks, such as local area networks (LANs), wide area networks (WANs), cellular telephone networks, and the like. Venue device 310, mobile devices such as user device 320, third-party server 350, server 330, and other devices can communicate with one another, at least partially, via one or more near field communications (NFC) methods or other short range communications methods, such as infrared (IR), Bluetooth, WiFi, and WiMax.

When a user wishes to shop for tickets online, the user can open an online ticket seller's website or can access the ticket seller using an application such as app 325. The user can open the ticket seller's website using user device 320, for example. The ticket seller's website can be hosted on ticket server 330, venue device 310, or on any other server or device.

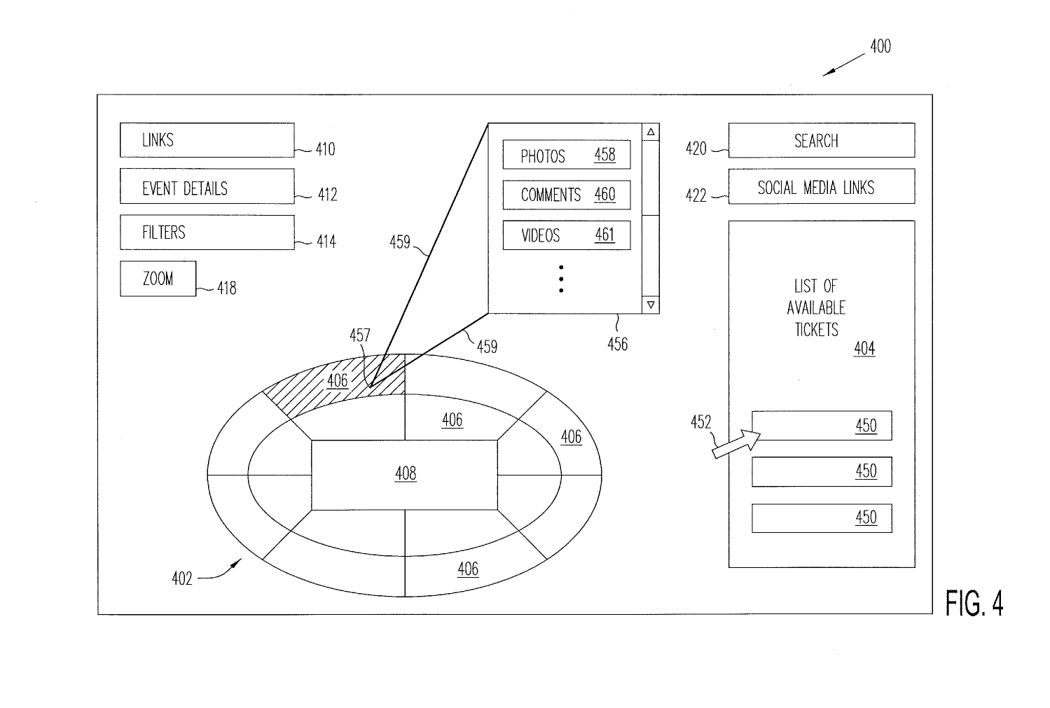

FIG. 4 is a diagram of a ticket seller website that is configured to facilitate selection and purchase of tickets for ticketed events. A website such as website 400 may be configured to provide enhanced ticket information such as community-sourced seat information to a user of the website (e.g., a user of ticket server 330).

As shown in FIG. 4, a website such as ticket seller website 400 may include a list such as list 404 of available tickets for an event. The event can be a concert, a sporting event, a user-generated event, or any other type of event for which tickets are sold. List 404 may include one or more available ticket indicators 450 that include information (e.g., seat location and price information) for one or more available tickets. Website 400 may be an implementation of web interface 122 of FIG. 1, may be provided to user device 320 by ticket server 330, or may be otherwise provided to or accessed by a potential ticket buyer.

In some embodiments, website 400 may also include a map such as venue map 402. Venue map 402 may be an interactive venue map or a non-interactive venue map that shows a seating diagram of a venue for a particular user-selected event. The event can be specified by the user by stating a name of the event, a venue, and/or a date. For example, a concert event for a particular artist at a particular arena on a particular date can be specified by entering the name of the artist, the name of the arena, and/or the date in one or more entry boxes such as search box 420 of website 400.

If the information entered is insufficient to uniquely identify the event, then website 400 can present the user with a list of possible events. For example, if the user only entered an artist name without stating a date or venue, then a list of upcoming concerts (tour dates) for that artist can be presented for the user to choose from. In this way, the user can quickly find the event for which tickets are desired. After the event has been uniquely identified, the user can be presented with map 402 and/or list 404 for the event.

Map 402 can show seating areas such as sections 406 and their relationship to an attraction area such as area 408 at the venue. Attraction area 408 may be a stage, a game court, or a field (as examples). The ticket prices for each section 406 can also be provided.

As shown in FIG. 4, some sections 406 may be displayed differently from other sections. For example, the cross-hatched section 406 in FIG. 4 may be a color coded section, a cross-hatched section, a grey section or may otherwise be displayed in a way that indicates seat-related information to the user. For example, the cross-hatched section may be a section with available tickets.

Map 402 and/or list 404 can be interactive. For example, in response to the user scrolling over an available ticket indicator 450 of list 404 with a cursor 452, tapping on an indicator 450 using a touch screen, or otherwise selecting an indicator 450, the ticket server can display an enhanced ticket information window 456 on website 400. Enhanced ticket information window 456 may include enhanced ticket information associated with the selected available ticket indicator 450. For example, window 456 may be used to provide community-sourced seat information associated with seats at the venue that can be reserved by purchasing the available tickets in that indicator.

As shown in FIG. 4, enhanced ticket information in window 456 may include seat information such as photos 458, comments 460, and videos 461. Photos 458, videos 461, and comments 460 may be community-sourced seat information such as community-sourced photos, community-sourced videos, and/or community-sourced comments that have been gathered from event attendee community members. Community-sourced seat information can be gathered from one or more email accounts, one or more social network accounts, and/or other online sources associated with one or more users of ticket server 330, one or more friends of a user of ticket server 330, users of other ticket providers, or other online sources.

Photos 458 may include photos taken by attendees of previous events at the venue from the same seat location (or the same seat section) as the seats for which tickets are available, as indicated by the selected indicator 450. Comments 460 may include comments posted online (e.g., on a social media webpage) by attendees of previous events at the venue that purchased tickets for, and/or sat in, the same seat location (or the same seat section) as the seats for which tickets are available as indicated by the selected indicator 450.

Photos 458 and/or comments 460 can be filtered for a particular user of website 400. For example, photos 458 and/or comments 460 can be photos and/or comments posted online by friends of the user, by others who attended the same type of event (e.g., a sporting event or a music concert) as the event for which tickets are available, by others who attended an event by the same artist for which tickets are available, and/or photos and/or comments posted online by the user.

Photos 458 and/or comments 460 can be gathered automatically by a ticket server using email accounts, social network accounts, ticket server user accounts, or other online sources associated with the user.

Window 456 may be a pop-up window, a portion of an indicator 450, a new browser window, a new browser tab, or may be otherwise displayed on website 400. In some embodiments, window 456 may be a selectable window (e.g., a clickable window) that, when selected, opens a new browser window, a new browser tab, or other dedicated enhanced ticket information display mechanism.

For example, a user who wishes to purchase event tickets for a performance of a particular artist at a particular venue may access website 400 and select an upcoming performance of the artist at the venue for which tickets are available. While viewing a list of available tickets, the user may scroll a cursor over a particular available ticket indicator and be presented with photos taken by a friend of the user at a previous performance of that artist at that venue in, if desired, those same seats or similar seats. In this way, the user can be provided with enhanced ticket information that gives the user a more complete understanding of the experience of sitting in those seats and thereby a more complete understanding of the value of the available tickets. In one particular example, the user's friend may have paid a premium price for front-row seats and posted photos and enthusiastic comments on a social media webpage describing the value of purchasing the front-row seats. A user who may not have otherwise considered purchasing front-row seats at a premium price may be presented with the posted photos and the enthusiastic comments and thereby persuaded by this type of enhanced, community-sourced seat information to purchase the premium priced tickets for the front-row seats.

Website 400 may also include additional features such as links 410, event details 412, zoom features 418, filters 414, social media links 422 and/or other suitable ticket-purchase related features.

Links 410 may include clickable links to other events such as upcoming events at the same venue, sporting events, concerts, theater events, fan services, user account services or other internal or external links.

Event details 412 may include graphical or text representations of the details of the selected event such as the artist name, the venue name, the date of the event, the time of the event, or other event related information.

Social media links 422 may include clickable links that allow a user to share event and/or ticket details with others through various social media servers.

Filters 414 may include a ticket price filter, a ticket quantity filter, a venue zone filter, a ticket delivery method filter, a seat feature filter or other ticket selection filters that affect the available tickets that are displayed on website 400.

Zoom feature 418 may be a clickable feature that allows the user to zoom into a particular portion of map 402. In this way, a user can view particular section numbers, individual rows of seats in a section, and/or individual seats or groups of seats that are available in a particular section for the selected event. In some embodiments, enhanced ticket information may be displayed in connection with a zoomed portion of map 402 such as a particular seat row, seat section, small group of seats (e.g., two seats, four seats, six seats, eight seats, ten seats, less than four seats, less than ten seats, between two seats and four seats, between two seats and ten seats, or more than 1 seat), or an individual seat.

In the example of FIG. 4, window 456 is displayed in a location that is associated with the location 457 of the seats in map 402 for which tickets in the selected available ticket indicator 450 are available. Window 456 can be displayed over a particular seat or particular section of map 402, may be displayed such that window 456 appears to originate from a particular seat or section of seats using indicator lines 459, or may be otherwise displayed in a location associated with seats in map 402. However, this is merely illustrative. In various embodiments, window 456 may displayed at an arbitrary location on website 400 or may be display at a location associated with the location of the selected indicator 450 in list 404.

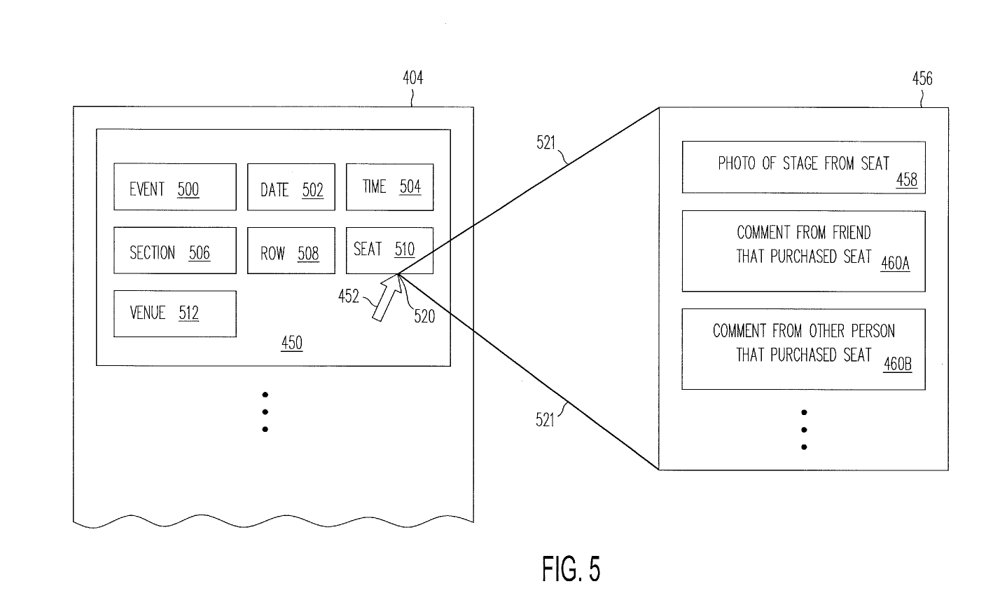

FIG. 5 shows a portion of website 400 in an embodiment in which enhanced ticket information window 456 is displayed at a location associated with the location of the selected indicator 450 in list 404. As shown in FIG. 5, enhanced ticket information window 456 may be displayed such that window 456 appears to originate from a location 520 within a selected available ticket indicator 450 using indicator lines 521 when a user moves a cursor 452 over that indicator 450 (or otherwise expresses interest in tickets of that indicator). For example, location 520 can be located over a seat information portion 510 of indicator 450. Seat information portion 510 may indicate a seat number or a group of seat numbers for which tickets associated with that indicator 450 are available (e.g., seats 1-4 in a particular row of seats at a venue). However, this is merely illustrative. If desired, location 520 may be located anywhere within indicator 450 or elsewhere in list 404 or window 456 may be displayed without any indicator lines to a particular location.

Available ticket indicator 450 may include information associated with the a particular ticket or group of tickets such as event information 500, event date information 502, event time information 504, seat section information 506, seat row information 508, seat number information 510, and venue information 512.

As shown in FIG. 5, photo 458 may be a photo of an event stage take from the seat indicated by seat number information 510, and comments 460 can include a comment 460A from a friend that previously purchased that seat (or similar seats) and a comment 460B from another person that has purchased that seat (or similar seats). In general community-sourced seat information to be provided to a user as enhanced ticket information for ticket selection and purchase operations can be seat information (e.g., photos, comments, etc.) gathered from a member of any suitable community of people such as a community of friends of the user that is selecting and purchasing tickets, a community of online ticket purchasers, a community of fans of a particular artist, a community of attendees of events held at a particular venue, a community of fans a particular artist that have attended events held at a particular venue, or any other group, sub-group, or individual that provides event-related data online.

In various embodiments, enhanced ticket information such as enhanced ticket information that is displayed in an enhanced ticket information window 456 may be displayed to a user when a user selects or indicates interest in a portion of list 404, a portion of map 402, or otherwise indicates an interest in purchasing tickets for a particular venue section, seat or group of seats. In one embodiment, enhanced ticket information window 456 may be displayed in a location 457 on map 402 when a user moves a cursor 452 over that portion of the map or otherwise indicates any interest in seats in that portion of the map (e.g., by tapping on a portion of touch screen). An enhanced ticket information window 456 that is displayed in connection with a location 457 in a venue map may include community-sourced seat information related to seats in a corresponding portion of the venue.

In some embodiments, map 402 of website 400 may be a static (non-interactive) map of an event venue or, particularly in the case of user-generated events, website 400 may be provided without a venue map. In situations in which a venue map is unavailable, a potential ticket purchaser may select tickets for purchase from list 404 of available tickets and be provided with enhanced ticket information in an enhanced ticket information window associated with the list (e.g., as shown in FIG. 5).

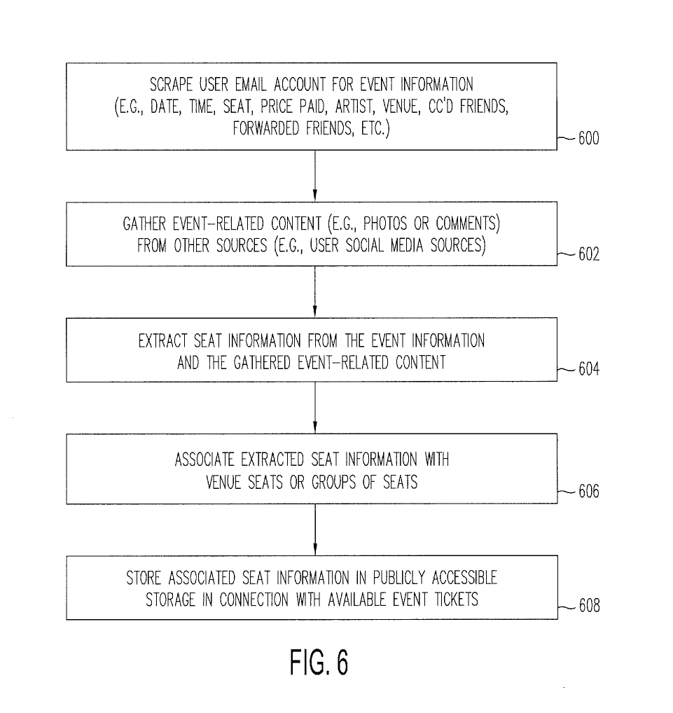

In order to gather seat information associated with particular seats or groups of seats from an online community of event attendees, computing equipment such as processor 331 of server 330 may perform some or all of the illustrative steps of FIG. 6.

At step 600, computing equipment such as one or more processors of ticket server 430, notification server 144 of system 110, other portions of system 110 or other suitable processors may scrape (e.g., access and search) a user email account of, for example, one or more users of a ticket server to obtain event information (e.g., event dates, event times, purchased seat locations, prices paid for tickets for particular seats, event artists/teams, event venues, copied (cc′d) friends on event emails, friends to whom event emails have been forwarded, and/or other event information such as emailed photos from attended events).

In one embodiment, the computing equipment may access a user's email account. A user's email account may include a list of emails (e.g., received emails or sent emails), each having email data such as a subject, a send date, body text, one or more senders, a recipient list (e.g., a carbon-copy (cc) list, a blind-carbon-copy (bcc) list, or other list of recipients of the email), or other data such as attached or embedded files. In some situations an email may be a confirmation email from a ticket seller notifying the email account holder that tickets for a ticketed event have been successfully purchased. Emails with purchased-ticket information such as confirmation emails from ticket sellers may be used to identify purchased-ticket events.

At step 602, the computing equipment may gather additional event-related content (e.g., photos, videos, and/or comments) from other sources such as user social media sources, online web-logs (blogs) discussing events, or other published sources. The event-related content may be gathered by, for example, by computing equipment such as a processor of server 430 and/or server 144 by accessing one or more social network accounts such as a user's social network account or a social network account of one of the user's email contacts as determined by scraping a user's email account at step 600 and gathering the event-related content from the social network account(s). If desired, the computing equipment may crawl public webpages (e.g., social network webpages or blogs) of contacts identified in email contacts associated with a user's email account to obtain additional event-related content.

A social network account may include posted social networking data such as one or more photos, one or more videos, one or more photo captions, one or more comments (e.g., user comments or user friend comments), and one or more social network contacts. Photos, captions, and/or comments may be posted to a social medial account by the owner of account or by others. The computing equipment may gather the social networking data from the social network account.

The event information and the event-related content can be stored temporarily or permanently in a non-transitory memory such as memory 432 of ticket server 431, a memory such as memory 214 of FIG. 2, a memory of one of the servers of system 110 (e.g., memory associated with notification server 144) or other suitable data storage.

At step 604, seat information may be extracted from the event information and the event-related content. The seat information may include photos, comments, or other information associated with particular venue seats. For example, the seat information may include any gathered comments that mention a seat number, a seat section, a view of a stage, an obstructed view, or other content associated with sitting at a particular seat and a venue. In another example, the seat information may include photos that have captions that mention a seat number, a seat section, a view of a stage, an obstructed view, or other content associated with sitting at a particular seat and a venue, photos with geo-tags that match a geographical location of a venue, a seat section, or a particular seat, photos with a filename that identifies an event, a venue, a seat section, or a particular seat, or photos with time stamps associated with a particular event.

For example, an attended event may be identified in a user email and a photo may be obtained from the user's social network account with a time stamp indicating a time during the identified event. The user email may also include information that indicates the seats at the venue in which the user sat during the identified event. The photo may then be determined to be seat information that can be provided to a future potential ticket purchaser. In another example, a user may post a photo on a blog with a caption that reads “Front row seats at the Bon Jovi concert last night” from which the location, time, date, and venue of the photo and comment can be determined.

At step 606, the computing equipment may associate the extracted seat information with particular seats or groups of seats at the venue. For example, if the user email included information that indicated that the user sat in Section 111, Row 3, Seats 1-4 at the identified event, the extracted photo may be associated with Section 111, Row 3, Seats 1-4 of the venue for that event.

At step 608, the computing equipment may store the associated seat information (e.g., the photo) in a publicly accessible storage (e.g., on a ticket server in a location accessible through a ticket server webpage such as webpage 400 of FIG. 4) in connection with available event tickets for a future event. In this way, community-sourced seat information from past events can be gathered and provided to a potential ticket buyer for future events.

In general, the steps described above in connection with FIG. 6 may be performed in any suitable order and/or combined in any suitable way for gathering event information and providing potential ticket buyers with community-sourced seat information for ticketed events.

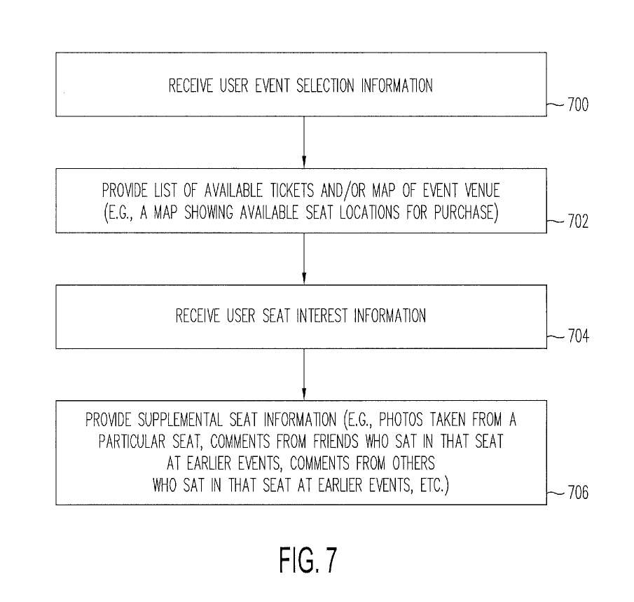

FIG. 7 is a flow chart of illustrative steps that may be used in providing enhanced ticket information for ticket selection and purchase services.

At step 700, a ticket provider such as ticket server 330 of FIG. 3 may receive user event selection information from a user device such as user device 320. The received user event selection information may be provided by the user when the user searches for and/or selects a particular event at a ticket server webpage such as website 400 of FIG. 4.

At step 702, the server may provide a list of available tickets associated with the available seats at the venue for the selected event and/or a map of the event venue to the user. The list of tickets and/or the map may be provided to the user on a ticket provider webpage as described above in connection with, for example, FIG. 4, may be provided in an app on a user device, or may be otherwise presented to the user. The list of tickets may include available ticket indicators that each indicate one or more available tickets for the selected event. The map may show seat locations at the venue and may indicate (e.g., by color coding or other visual indications) the locations of seats for which tickets are available for the selected event.

At step 704, the server may receive user seat interest information from the user. The user seat interest information may be, for example, data from the user device that indicates that the user has positioned a cursor over an available ticket indicator in the list of tickets, positioned a cursor over a portion of the provided map, or otherwise indicated interest in a particular seat or group of seats at the venue (e.g., using a keyboard, a touchscreen, voice or other data input mechanisms).

At step 706, in response to the user seat interest information received at step 704, the server may provide supplemental seat information such as community-sourced seat information, as described herein, to the user. As examples, the enhanced ticket information may include content that has been gathered from various sources such as email accounts, social media accounts and/or websites, blogs, or other online sources as described above in, for example, the steps of FIG. 6. The content may include (as examples) photos taken from a particular seat (or group of seats), videos taken from a particular seat (or group of seats), comments from user friends who sat in that seat (or group of seats) or in similarly located seats (e.g., seats in the same section, seats in the same row, seats in nearby rows or seats in nearby sections) at earlier events, and/or comments from others (e.g., artist fan community members, venue attendee community members, or residents of a common neighborhood, city or state) who sat in that seat (or group of seats) or in similarly located seats (e.g., seats in the same section, seats in the same row, seats in nearby rows or seats in nearby sections) at earlier events.

As described herein, providing the enhanced ticket information may include filtering the enhanced ticket information to include information that is particularly relevant to the user such as seat information obtained from friends of the user, people in the user's social networks, or people with similar interests to the user (as examples).

The enhanced ticket information may be gathered automatically by a server such as ticket server 330 (see, e.g., FIG. 3) as described above in connection with FIG. 6 (for example), and/or may be gathered by a direct interaction with a user.

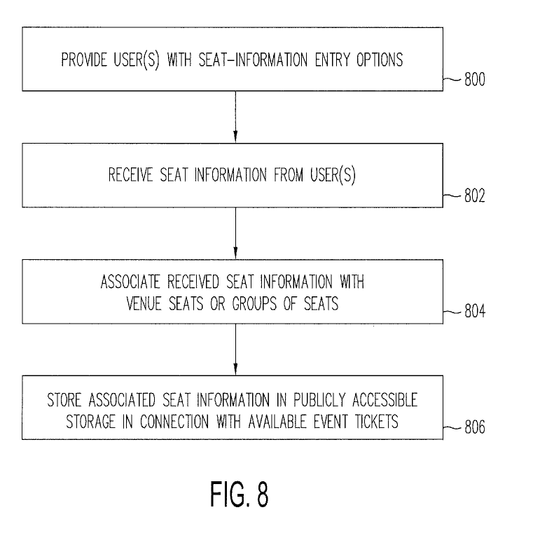

In order to gather seat information associated with particular seats or groups of seats from an online community of users in a direct interaction with the users, computing equipment such as processor 331 of server 330 may perform some or all of the illustrative steps of FIG. 8.

At step 800, one or more users may be provided with seat-information entry options. Seat-information entry options may include an email or text message invitation to a known event attendee to provide photos, videos, comments, or other information about the user's experience at an event, may include a chat webpage associated with an event, an artist, or a venue (as examples) that is hosted by a ticket server, may include a prompt on a user device generated by an app running on the user device for the user to provide seat information or other information about their experience at an event, or other seat-information entry options. In some embodiments, seat-information entry options may also be provided to users that have not attended a particular event, but are connected to an event attendee, an artist, or a venue (as examples). For example, an attendee of a football game at a stadium may be prompted by an app on a user device to provide a photo or comment about their experience in a particular seat. Contacts of the user such as email contacts or social network contacts may be notified of seat information provided by the user and provided with options (e.g., by email, chat page, etc.) to enter additional information if they have attended events at the same stadium.

At step 802, the server may receive any seat information provided by the user or users.

At step 804, the received seat information may be associated with venue seats or groups of seats. The received seat information may be associated with the seats using information provided directly from the user at step 800 or using additional information such as purchase history information for the user.

At step 806, the server may store the associated seat information in a publicly accessible storage (e.g., on a ticket server in a location accessible through a ticket server webpage such as webpage 400 of FIG. 4) in connection with available event tickets for a future event. In this way, community-sourced seat information from past events can be gathered directly from users and provided to a potential ticket buyer for future events.

In various embodiments, ticketed events such as the events described above can be social or recreational events, such as concerts, musicals, shows, fairs, amusement parks, sporting events and the like. Alternatively, such events can be business related events, such as business meetings, conferences, retreats, and the like.

Although the foregoing invention has been described in detail by way of illustration and example for purposes of clarity and understanding, it will be recognized that the above described invention may be embodied in numerous other specific variations and embodiments without departing from the spirit or essential characteristics of the invention. Various changes and modifications may be practiced, and it is understood that the invention is not to be limited by the foregoing details, but rather is to be defined by the scope of the claims.

What is claimed is:

1. A system for selection and purchase of tickets for a ticketed event at a venue, comprising:
a memory configured to store event information associated with the ticketed event; and
a processor coupled to the memory, wherein the processor is configured to obtain seat information associated with seats at the venue from an online community, receive information from a user that the user is interested in the seats, and provide at least a portion of the obtained seat information associated with the seats to the user.

2. The system defined in claim 1, wherein the processor is further configured to provide a list of available tickets for the ticketed event to the user.

3. The system defined in claim 2, wherein the list of available tickets includes at least one available ticket indicator associated with the seats and wherein the received information from the user comprises a selection by the user of the at least one available ticket indicator.

4. The system defined in claim 2 wherein the processor is further configured to provide a map of the venue for the ticketed event to the user.

5. The system defined in claim 4, wherein the received information from the user comprises a selection by the user of a portion of the map.

6. The system defined in claim 1, wherein the processor is configured to provide the at least the portion of the obtained seat information associated with the seats to the user in an enhanced ticket information window on a webpage.

7. The system defined in claim 1, wherein the obtained seat information comprises at least one photo taken from the seats by an attendee of a previous event at the venue.

8. The system defined in claim 7, wherein the processor is configured to obtain the seat information associated with the seats by obtaining the at least one photo from a friend of the user.

9. The system defined in claim 7, wherein the processor is configured to obtain the seat information associated with the seats by obtaining the at least one photo from a member of a social network of the user.

10. The system defined in claim 1, wherein the obtained seat information comprises at least one published online comment about an experience associated with the seats by an attendee of a previous event at the venue.

11. The system defined in claim 1, wherein the processor is configured to obtain the seat information associated with the seats by scraping an email account of at least one additional user.

12. The system defined in claim 1, wherein the processor is configured to obtain the seat information associated with the seats from a social network account of at least one additional user.

13. A method, comprising:
receiving, electronically by a ticket server processor, a selected event to be held at a venue from a user;
providing, electronically by the ticket server processor, a list of available tickets for the selected event to the user;
receiving, electronically by the ticket server processor, user seat interest information associated with seats at the venue from the user; and
providing, electronically by the ticket server processor, community-sourced seat information associated with the seats to the user.

14. The method defined in claim 13, wherein the providing of the community-sourced seat information comprises providing a photo taken from a selected one of the seats.

15. The method defined in claim 13, wherein the providing of the community-sourced seat information comprises providing a comment from an attendee of a previous event that purchased a ticket for a selected one of the seats.

16. The method of claim 13, further comprising:
scraping, electronically by a processor, a plurality of email accounts to obtain event information;
gathering, electronically by the processor, event-related content from a plurality of social network accounts; and
extracting, electronically by the processor, the community-sourced seat information from the obtained event information and the gathered event-related content.

17. A non-transitory machine-readable medium having a plurality of machine-readable instructions which, when executed by one or more processors of a server, are adapted to cause the server to perform a method comprising:
receiving a selected event to be held at a venue from a user;
providing a list of available tickets for the selected event to the user;
receiving user seat interest information associated with seats at the venue from the user; and
providing community-sourced seat information associated with the seats to the user.

18. The non-transitory machine-readable medium defined in claim 17, wherein the providing of the community-sourced seat information comprises providing a photo taken from a selected one of the seats.

19. The non-transitory machine-readable medium defined in claim 17, wherein the providing of the community-sourced seat information comprises providing a comment from an attendee of a previous event that purchased a ticket for a selected one of the seats.

20. The non-transitory machine-readable medium defined in claim 17, wherein the method further comprises:
scraping a plurality of email accounts to obtain event information;
gathering event-related content from a plurality of social network accounts; and
extracting the community-sourced seat information from the obtained event information and the gathered event-related content.
